(19) United States
(12) Patent Application Publication
(10) Pub. No.: US 2007/0110919 A1
(43) Pub. Date: May 17, 2007

(54) Method for producing photocatalytically active polymers

(75) Inventors: Reinhard Ballhorn, Darmstadt (DE); Heinrich Kreye, Hamburg (DE); Torsten Stoltenhoff, Ennepetal (DE); Jaromir Jirkovsky, Prag (CZ); Igor Burlacov, Dresden (DE); Frantisek Peterka, Prag (CZ); Ladislav Kavan, Prague (CZ)

Correspondence Address: CROWELL & MORING LLP;INTELLECTUAL PROPERTY GROUP, P.O. BOX 14300, WASHINGTON, DC, 20044-4300, US

(73) Assignees: ATG Advanced Technology Group s.r.o., Praha (CZ); Linde AG, Wiesbaden (DE)

(21) Appl. No.: 11/272,738

(22) Filed: Nov. 15, 2005

(51) Int. Cl. H05H 1/24

(52) U.S. Cl. 427/569

(57) ABSTRACT

For producing photocatalytically active polymer surfaces, a method is indicated by which particles of the photocatalytically active oxidic material are accelerated by a carrier gas, when impacting on the polymer surface, partially penetrate into the polymer and, as a result of their high kinetic energy, form a mechanically firmly adhering polymer/oxide bond.

### BACKGROUND AND SUMMARY OF THE INVENTION

The invention relates to a method of producing photocatalytically active coatings on polymers in a cold-gas spraying process, wherein powder particles of the photocatalytically active material are accelerated in a carrier gas to speeds of up to 1,500 m/s and upon impact penetrate into the surface of the polymer to a depth of several micrometers to form a mechanically firmly adhering laminar structure with the polymer. The carrier gas is relaxed at an output pressure of up to 6.3 MPa and an output temperature of up to 800° C. in a supersonic nozzle or sonic nozzle and in the process is accelerated to speeds of up to 1,500 m/s. FIG. 1 is a schematic view of the process. In FIG. 1, the nozzle can comprise a Laval nozzle and can be moved by means of a robot arm in order to permit a suitable rastering over the substrate surface.

It is known to apply coatings to substrates of many different types by means of various methods. Investigations are described in the literature where photocatalytically active coatings are produced by different methods. See, e.g., German Patent No. DE 10119288, U.S. Patent Application No. 2002/0168466 and H. Ohsaki et al., Plasma Treatment for Crystallization of Amorphous Thin Films, Proceed. 5^{th} ICCG, Saarbrücken, 2004. Plasma spraying has been disclosed in articles by F. X. Ye et al., Investigation of the Photocatalytic Efficiencies of Plasma Sprayed TiO₂—Fe₂O₃ Coatings (S. 169-174) and by N. Berger-Keller et al., Influence of Plasma Spray Parameters on Microstructural Characteristics of TiO₂ Deposits (S. 1403-1408), both of which appeared in Thermal Spray 2003: Advancing the Science & Applying the Technology, C. Moreau and B. Marple (Eds.), ASM International Materials Park, Ohio (2003). Chemical vapor deposition (CVD) of photocatalytically active coatings has been described by S. A. O'Neill et al., Chem. Mater., 15, 46-50 (2003), and the sol-gel coating of photocatalytically active coatings has been described by M. Z. Atashbar, et al., Thin Solid Films, 326, 238-244 (1998). Other deposition methods include high-speed flame spraying (HVOF) and sputtering. It is the object of this work to achieve an optimal method of operation of the photocatalytic layer, for example TiO₂, for the respective application by means of targeted process parameters.

It is also known that titanium dioxide occurs in different modifications. In addition to the stable rutile phase, titanium dioxide can also occur in the photocatalytically active anatase phase which, however, irreversibly changes to rutile above the temperature range of from 600-800° C. The titanium dioxide can be produced in different manners as powder in the form of the anatase phase. During conventional thermal spraying of anatase powders, however, this TiO₂ phase changes partially or completely to the rutile phase, whereby the photocatalytic characteristics of the produced layer are impaired or lost. This disadvantage can be partially compensated by doping with Nb₂O₅. The effects of doping have been described by M. Sacerdoti et al., J. Sold State Chem., 177, 1781-1788 (2004), J. Arbiol et al., J. Appl. Phys., 92(2), 853 (2002), B. M. Reddy et al., J. Mater. Sci. Lett., 17, 1913-1915 (1998), and H. Cui et al., J. Solid State Chem., 115, 187-191 (1995).

The formation on polymer substrates of oxide coatings using reactive magnetron sputtering and electron beam evaporation, respectively, has been described by Y. Shigesato (Proceed. 5^{th} ICCG, Saarbrücken, 2004) and K. Lau et al. (Proceed. 5^{th} ICCG, Saarbrücken, 2004). These methods require high expenditures and cost and the produced layers are of a thickness of only some 100 nanometers. TiO₂ layers can also be produced by dip coating which has to be followed by a calcining step. Because of the thermal stress, this process and most thermal spraying methods are not suitable for the coating of polymers.

Furthermore, cold gas spraying (CGS) has been described as a method for coating a metal surface with another metal (see, e.g., J. Voyer et al., Development of Cold Gas Sprayed Coatings, S. 71-78, Thermal Spray 2003: Advancing the Science & Applying the Technology, C. Moreau and B. Marple (Eds.), ASM International Materials Park, Ohio (2003)). For building up a firmly adhering layer, the ductile behavior of the powder as well as of the surface to be coated play an important role. Metallic powders, such as Cu, Al, Ni, Ti and their alloys are blasted at a high speed of typically between 500 and 1,000 m/s and at temperatures of typically up to 300° C. onto a substrate and, as a result of plastic deformation, build up a firmly adhering layer there. The temperature of the process gas by means of which the particles area accelerated and heated typically amounts to from 300-600° C. It is therefore very clearly below the melting point of the powdery material as well as of the substrate. As disclosed by T. Stoltenhoff in Proc. ITSC, May 5-8, 2003, Orlando, Fla., during cold gas spraying of metal coatings, the metal powder particles undergo only slight changes in microstructure, crystal structure and oxidation state. An important process parameter is the speed of the particles before they impact on the substrate surface. In this case, each material has a critical speed above which the adhesion takes place. The impact speed of the particles is important for achieving a strong bond. Adhesion takes place when a material-specific critical speed is exceeded. This is determined by the characteristics of the material of the powder and the substrate and, in addition, depends on the temperature of the particles and of the substrate at the moment of the impact.

C. J. Li et al. (Proc. ITSC, May 10-12, 2004, Osaka, Japan) have disclosed the formation using powder spraying of thin, discontinuous TiO₂ layers on a metal substrate. The thickness of the layer amounted to <15 μm. However, still no closed layer could be produced, so that its photocatalytic effect was limited because the UV energy was not optimally utilized. It has not been known from the literature that polymer surfaces can be coated with oxidic powders by means of cold-gas spraying.

### BRIEF DESCRIPTION OF THE DRAWINGS

FIG. 1 shows a schematic illustration of a cold gas spray apparatus.

FIG. 2 shows Micro-Raman spectra of anatase coatings formed on polymer substrates.

FIG. 3 shows the experimental setup for measuring catalytic activity.

FIG. 4 shows a comparison of pH as a function of time for anatase coatings formed by cold gas spraying formed on polymer substrates, and comparative thermally sprayed titanium dioxide coatings formed on polymer substrates.

### DETAILED DESCRIPTION OF THE DRAWINGS

Our own work has shown that photocatalytically very efficient layers can be applied to polymer surfaces by means of cold-gas spraying. The layers are characterized by a considerable layer thickness (>15 μm) which, on the one hand, protects the polymer substrate from degradation by UV radiation, which is not ensured in the case of other low-temperature coating processes, and, on the other hand, can optimally utilize the UV energy. The high photocatalytic activity is determined particularly by the high specific surface of the layer, that is its high roughness or porosity.

In contrast to a metal surface, the powder particles, when the polymer surface is bombarded, penetrate several μm deep into the polymer, and a firm bond is formed between the oxidic powder and the polymer. In the case of conventional coating techniques of polymer surfaces with oxidic layers, the considerable difference in the thermal coefficient of expansion leads to problems (forming of cracks, chipping, etc., as described by R. P. Shimshock in Proceed. 5^{th} ICCG, Saarbrücken, 2004). Oxide/polymer bonds, which were produced by cold-gas spraying, surprisingly do not exhibit the expected temperature-related sensitivity.

For coating PET, PSU and PEEK surfaces with TiO₂, the cold-gas spraying parameters listed in Table 1 were selected. PET is an abbreviation for polyethylene terephthalate, PSU is an abbreviation for polysulfone and PEEK is an abbreviation for polyetheerether ketone.

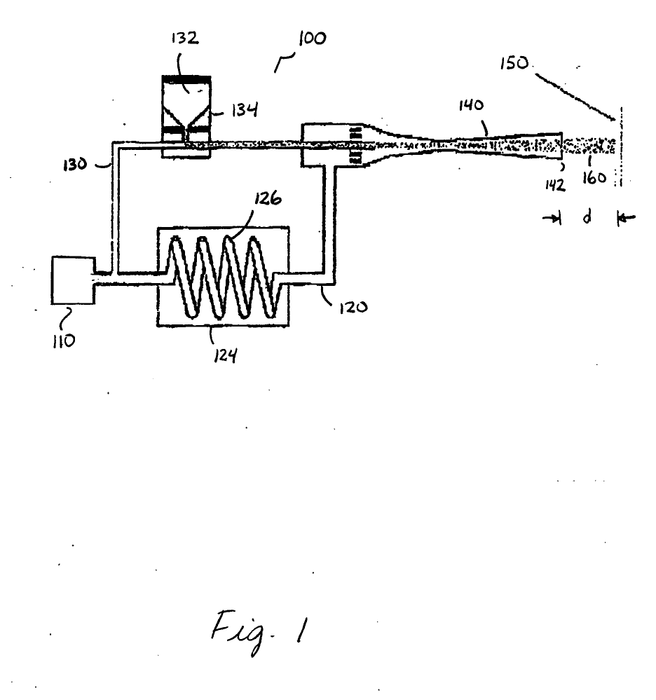

A schematic illustration of an exemplary system for cold gas spraying is shown in FIG. 1. System 100 comprises gas source 110, which is adapted to supply a carrier gas through both a gas heater line 120 and a powder feeder line 130. The carrier gas is supplied to the gas heater line 120 and the powder feeder line 130 at a pressure of from about 1 to 35 MPa. The gas can be heated in the gas heater line 120 to a desired temperature as it flows through heater coils 126 of gas heater 124. Preferably, the gas is heated to a gas temperature of about 100 to 800° C. Powder particles 132, which are supplied via powder feeder 134, can be entrained in the carrier gas as it flow through the powder feeder line 130. The gas-entrained powder particles and the heated gas are combined in nozzle 140, which can comprise a Laval type nozzle, and a heated gas stream comprising the powder particles is directed toward a substrate 150 that is positioned at a distance (d) from the output 142 of the nozzle. A preferred substrate-nozzle distance (d) is between about 10 and 50 mm (e.g., 10, 20, 30, 40 or 50 mm). According to an embodiment, the particle stream 160, can be rastered (e.g., translated) with respect to a surface of the substrate 150 in order to form a coating over an expanded area of the substrate. For example, the nozzle 140 can be moved using a robot arm.

TABLE 1
Cold-gas spraying parameters.

| Parameter (units) | Value |
|---|---|
| Process Gas | Nitrogen |
| Powder composition, particle size (μm) | TiO₂, 20-40 |
| Process Gas Pressure (MPa) | 3 |
| Process Gas Temperature (° C.) | 400-550 |
| Substrate-nozzle distance (mm) | 30 |

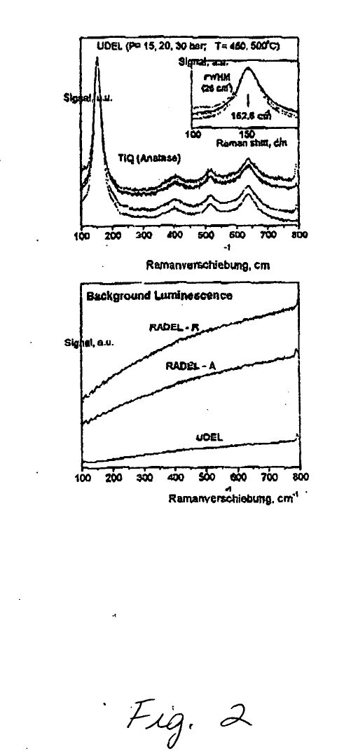

Using the parameters of Table 1, homogeneous thin firmly adhering anatase layers were obtained whose structure was determined by micro-Raman spectroscopy. It is found that the layer consists entirely of the photocatalytically particularly active anatase modification of the titanium dioxide (FIG. 2).

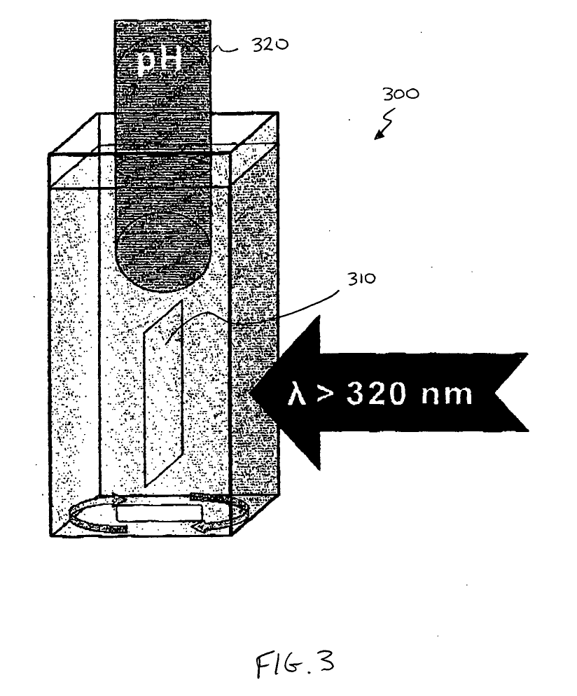

The layers were tested with respect to their photocatalytic efficiency in contact with a solution of 4-chlorophenol and sodium perchlorate under UV irradiation (λ>320 nm). A schematic of a Miniphoto reactor 300 for determining the photocatalytic activity of titanium dioxide layers is shown in FIG. 3.

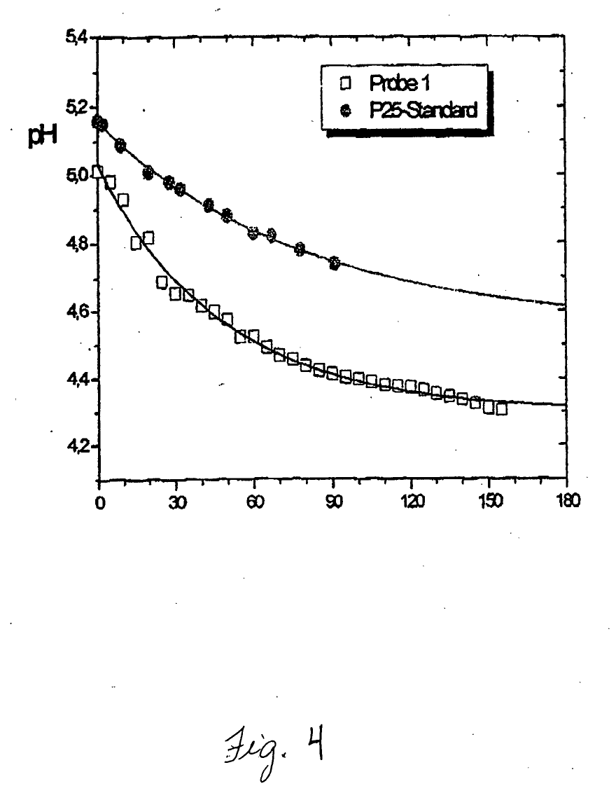

The coated test specimens 310 had the dimension of 12×8 mm. They were fixed in a standard cell for spectroscopy, which was filled with an aqueous solution of a 0.01 molar 4-chlorophenol and a 0.01 molar sodium perchlorate solution. The specimen fixed in the cell was irradiated by means of polychromatic UV light (wavelength>320 nm). In order to measure the photocatalytic activity, the pH change, which is proportional to the photocatalytic activity, was continuously measured by means of an electrode 320. A specimen of the same size, which was covered with a sedimented and calcined layer of TiO₂ powder of Degussa Company, was used as the comparison specimen. A plot of the kinetic dependence of the pH value versus irradiation time via the photocatalytic reduction of 4-chlorophenol is shown in FIG. 4.

All of the above-mentioned references are herein incorporated by reference in their entirety to the same extent as if each individual reference was specifically and individually indicated to be incorporated herein by reference in its entirety.

While the invention has been described with reference to preferred embodiments, it is to be understood that variations and modifications may be resorted to as will be apparent to those skilled in the art. Such variations and modifications are to be considered within the purview and scope of the invention as defined by the claims appended hereto.

What is claimed is:

1. Method of producing photocatalytically active polymer surfaces of different compositions, wherein a mechanically firmly adhering layer with photocatalytic characteristics is produced by means of cold-gas spraying (CGS) of an oxidic powder on a polymer substrate.

2. Method according to claim 1, wherein helium, argon, nitrogen, air or a mixture of these gases is used as the process gas for the spraying process.

3. Method according to claim 1, wherein a film, a plate or tube of variable dimensions is coated as the substrate.

4. Method according to claim 1, wherein the polymer substrate has a thermal stability greater than 100° C.

5. Method according to claim 1, wherein the polymer is stable with respect to ultraviolet irradiation.

6. Method according to claim 1, wherein the substrate is made of polyethylene terephthalate, polyetheretherketone, polysulfone, polyphenylene oxide/sulfone, polyether sulfone, an aromatic polyamide or a block copolymer thereof.

7. Method according to claim 1, wherein the oxidic powder is a ceramic powder.

8. Method according to claim 7, wherein the oxidic powder is titanium dioxide.

9. Method according to claim 8, wherein the titanium dioxide is present in its anatase modification.

10. Method according to claim 8, wherein the titanium dioxide is doped with a transition metal oxide.

11. Method according to claim 8, wherein the titanium dioxide is doped with ZnO, Nb₂O₅ or Ta₂O₃.

12. Method according to claim 10, wherein the dopant has a concentration of from 0.1 to 99.9% by weight or from 0.6 to 5% by weight.

13. Method according to claim 1, wherein the oxidic powder has a particle size of from 1 to 150 micrometers or from 5-50 micrometers.

14. Method according to claim 1, wherein the oxidic powder comprises an agglomerate of smaller particles.

15. Method according to claim 14, wherein the agglomerated particles are microcrystalline with a grain size of from 0.1 to 1 micrometers.

16. Method according to claim 14, wherein the agglomerated particles are nanocrystalline with a grain size of from 1 to 200 nm or from 1 to 20 nm.

17. Method according to claim 1, wherein the oxidic ceramic powder is applied to the substrate by means of cold-gas spraying and a laminar structure is thereby obtained of the photocatalytically active material and a polymer-containing substrate matrix.

18. Method according to claim 1, wherein the oxidic ceramic powder is applied together with a ductile metal to the substrate by means of cold-gas spraying and a bond is thereby formed consisting of the photocatalytically active material, the metal and a polymer-containing substrate matrix.

19. Method according to claim 1, wherein an adhesion-promoting layer comprising a metal or a ceramic material is applied to the substrate using cold-gas spraying, thermal spraying, chemical vapor deposition (CVD), physical vapor deposition (PVD) or ion beam sputtering, and a layer of a photocatalytically active oxidic ceramic powder is applied to the adhesion-promoting layer by means cold-gas spraying, and a bond is thereby formed between the photocatalytically active material, the adhesion-promoting layer and the substrate.

20. Method according to claim 1, wherein complexly constructed layers can be formed by repeated over-runs of a cold-gas beam.

21. A photocatalytically active coated polymer substrate produced by the method according to claim 1.

22. A method of forming a photocatalytically active coating on an exposed surface of a polymer substrate using cold-gas spraying, said method comprising the steps of:
entraining powder particles of a first photocatalytically active transition metal oxide in a carrier gas stream; and
depositing the first powder particles on an exposed surface of the substrate in an amount effective to form a continuous coating of the photocatalytically active transition metal oxide on the exposed surface.

23. Method according to claim 22, wherein at least some of the first powder particles penetrate into the surface of the substrate.

24. Method according to claim 22, wherein the thickness of the coating is greater than 15 micrometers.

25. Method according to claim 22, wherein the steps of entraining and depositing are repeated for second powder particles, wherein the second powder particles are different than the first powder particles.
